(19) United States
(12) Patent Application Publication
(10) Pub. No.: US 2018/0058529 A1
(43) Pub. Date: Mar. 1, 2018

(54) SELF-LOCKING BRAKING SYSTEM AND METHOD

(71) Applicants: CENTRE FOR IMAGING TECHNOLOGY COMMERCIALIZATION, London (CA); THE UNIVERSITY OF WESTERN ONTARIO, London (CA)

(72) Inventors: Jeffrey BAX, London (CA); Christopher WARING, London (CA); Aaron FENSTER, London (CA); Jeremy CEPEK, Wyoming (CA)

(21) Appl. No.: 15/563,040

(22) PCT Filed: Mar. 31, 2015
(86) PCT No.: PCT/CA2015/000209

§ 371 Date: Sep. 29, 2017

(51) Int. Cl. F16D 71/04; F16D 49/00; F16D 65/14

(52) U.S. Cl. CPC F16D 71/04; F16D 2121/14; F16D 65/14; F16D 49/00

(57) ABSTRACT

A self-locking brake mechanism, which utilises a cantilever to engage a brake drum to prevent the brake drum from rotating, thereby resulting in braking behaviour. Further, locking mechanisms are provided that are useful for applications involving multiple brakes. The locking mechanism, through suitable use of indexing via Geneva mechanisms, allows multiple brakes to be engaged and/or disengaged from a single point of adjustment. The multiple brakes may be engaged or disengaged in a variety of combinations to achieve a particular desired braking configuration. The user can turn a single knob to engage or disengage varying combinations of brakes so as to achieve the desired braking configuration.

### FIELD OF THE INVENTION

The present invention relates generally to the field of locking mechanisms, and more particularly to unidirectional and bidirectional self-locking or braking mechanisms and to mechanisms for the indexed braking of such self-locking or braking mechanisms.

### BACKGROUND OF THE INVENTION

For devices which, during operation, require movement along multiple degrees of freedom, it may sometimes be necessary to control or limit such movement by braking or locking the device entirely or locking its movement along particular degrees of freedom. Conventionally, this can be achieved by providing individual brakes which can separately be actuated to engage or disengage each such brake. An example which serves to illustrate this issue, is in the case of a device used in magnetic resonance image-guided focal therapy, where said device consists of two parallel arms each having at least two degrees of freedom. An operator of such a device may wish to have the ability to lock or unlock these arms, for example, at certain points during a procedure (it may also in some instances be desirable to engage certain brakes and to disengage others). The conventional approach would be to have independent brakes at each of the arms and simply actuate each of these brakes separately, as desired. However, this approach is rather cumbersome, time-consuming, and prone to error; furthermore, it does not provide the operator with a clear visual indication of which brakes have been engaged or disengaged.

Accordingly, there is an advantage in providing a self-locking brake mechanism, which can be readily engaged and disengaged, and which in particular requires relatively little force on the part of a user to engage the brake (relative to the braking force that is applied to the brake during its engagement).

There is also an advantage in providing a locking mechanism for multiple brakes, wherein the locking mechanism allows multiple brakes to be engaged and disengaged from a single point of adjustment.

### SUMMARY OF THE INVENTION

Disclosed herein is a self-locking brake mechanism, which utilises a bending beam or cantilever that can be deflected into a brake drum, resulting in braking behaviour.

In accordance with an aspect of the present invention, a self-locking braking system is provided, comprising: a resilient support; a beam, more preferably a cantilever, having a first end and a second end, the first end fixedly connected to the resilient support and a second end proximal to a rotatable drum rotatable in a first and second rotation direction; and a deflecting means; wherein the resilient support and the deflecting means are configured to interact with each other to cause the beam to deflect and the second end of the beam to frictionally engage the rotatable drum at a point of engagement, where the torque generated by rotation of the drum in the first rotation direction is less than or equal to the force of friction at the point of engagement.

In accordance with another aspect, a self-locking braking system is provided, comprising: a first and second resilient support; a first beam or cantilever having a first end and a second end, the first end fixedly connected to the resilient support and a second end proximal to a rotatable drum rotatable in a first and second rotation direction; a second beam or cantilever having a first end and a second end, the first end fixedly connected to the second resilient support and a second end proximal to the rotatable drum; and a first deflecting means and a second deflecting means; wherein the first resilient support and the first deflecting means are configured to interact with each other to cause the first beam or cantilever to deflect and the second end of the first beam or cantilever to frictionally engage the rotatable drum at a first point of engagement, where the torque generated by rotation of the drum in the first rotation direction is less than or equal to the force of friction at the first point of engagement, and wherein the second resilient support and the second deflecting means are configured to interact with each other to cause the second beam or cantilever to deflect and the second end of the second beam or cantilever to frictionally engage the rotatable drum at a second point of engagement, where the torque generated by rotation of the drum in the second rotation direction is less than or equal to the force of friction at the second point of engagement.

In accordance with another aspect, a system for indexed braking of a plurality of brake drums is provided, comprising: a plurality of the self-locking braking systems described above; a plurality of Geneva mechanisms, wherein each Geneva mechanism is engaged with at least one of the plurality of self-locking braking systems; and a rotatable drive shaft engaged with each of the plurality of Geneva mechanisms, wherein the rotation of the drive shaft through different positions provides of selective engagement and disengagement of each of the plurality of rotatable drums.

In accordance with an aspect of the present invention, disclosed herein is a locking mechanism that is useful for applications involving multiple brakes, which locking mechanism allows multiple brakes to be engaged and/or disengaged from a single point of adjustment. The locking mechanism utilises the above-mentioned self-locking brake mechanism to effect the required braking. The multiple brakes may be engaged or disengaged in a variety of combinations to achieve a particular desired braking configuration. This avoids the operator having to interact with an individual actuator for each brake. The operator can turn a single knob to engage or disengage varying combinations of brakes so as to achieve the desired braking configuration.

The present invention is of relatively simple construction, and as such, can be manufactured from non-magnetic materials, thus allowing it to be used in magnetically sensitive environments, such as in the bore of a magnetic resonance (MR) scanner.

Further, the present invention can be a purely mechanical device, which, as such, does not require the use of additional pneumatics, hydraulics or electronics, which may be required for conventional braking methods.

### BRIEF DESCRIPTION OF THE DRAWINGS

The novel features which are believed to be characteristic of the apparatus and method according to the present invention, as to their structure, organization, use, and method of operation, together with further objectives and advantages thereof, may be better understood from the following drawings in which presently preferred embodiments of the invention may now be illustrated by way of example. It is expressly understood, however, that the drawings are for the purpose of illustration and description only, and are not intended as a definition of the limits of the invention. In the accompanying drawings:

FIG. 1 is a diagram illustrating some of the parameters which relate to the force required to deflect a cantilevered beam, with a single point load located anywhere along the length of the beam.

FIG. 2a is a diagrammatic representation of a one-way brake utilising a cantilevered beam, where the brake is shown in an engaged position.

FIG. 2b is a diagrammatic representation of a one-way brake utilising a cantilevered beam, where the brake is shown in a disengaged position.

FIG. 2c is a diagrammatic representation of a one-way brake utilising a cantilevered beam, where the beam is in an undeflected position. In this position, the brake is in a neutral position and can be moved into an engaged or disengaged position.

FIG. 3a is a diagrammatic representation of a two-way brake utilising cantilevered beams, where the brake is shown in an engaged position.

FIG. 3b is a diagrammatic representation of a two-way brake utilising cantilevered beams, where the brake is shown in a disengaged position. In this position, the brake is in a neutral position and can be moved into an engaged or disengaged position.

FIG. 3c is a diagrammatic representation of a two-way brake utilising cantilevered beams, showing the beams are in an undeflected position. In this position, the brake can be engaged or disengaged.

FIG. 4a is a sectional view illustrating a cam mechanism that may be used to synchronize the beam carriage motion, showing the brake in a fully engaged position.

FIG. 4b is a sectional view illustrating a cam mechanism that may be used to synchronize the beam carriage motion, showing the brake in a disengaged position.

FIG. 4c is a sectional view illustrating a cam mechanism that may be used to synchronize the beam carriage motion, showing the brake in a fully engaged position.

FIG. 4d is a sectional view illustrating a cam mechanism that may be used to synchronize the beam carriage motion, showing the brake in an disengaged position.

FIG. 5a is a perspective view of a brake test bed of the brake from FIG. 4a operating in conjunction with a Geneva mechanism.

FIG. 5b is a perspective view of a brake test bed of the brake from FIG. 5a, with the brake shaft handles removed for easier reference.

FIG. 6 is a brake test bed of a brake with a single beam using a cam of a different design as the one shown in FIGS. 4 and 5.

FIG. 7 is a perspective view of a brake test bed of the single-beam brake from FIG. 6 operating in conjunction with a Geneva mechanism.

FIG. 8 is a perspective view of a brake test bed of a brake using a box frame and cam design.

FIG. 9 is a perspective view of a brake test bed which incorporates a single beam and toggle mechanism.

### DETAILED DESCRIPTION OF THE PREFERRED EMBODIMENTS

The description that follows, and the embodiments described therein, is provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly depict certain embodiments and features of the invention.

In this disclosure, a number of terms and abbreviations are used. The following definitions of such terms and abbreviations are provided.

As used herein, a person skilled in the relevant art may generally understand the term “comprising” to generally mean the presence of the stated features, integers, steps, or components as referred to in the claims, but that it does not preclude the presence or addition of one or more other features, integers, steps, components or groups thereof.

As used herein, a person skilled in the relevant art may generally understand the term “braking” as used herein to refer to an input force inhibiting motion, slowing or stopping a moving object or preventing its motion. As used herein, a person skilled in the relevant art would understand that the term “locking” to refer to the action by which a moving object or component is prevented from moving freely by the engagement of a lock; as such, the terms “braking” and “locking” herein may be used interchangeably. It may be further understood that the term “self-locking” as used herein refers to where frictional forces are high enough, no amount of load force can overcome the braking or locking of the embodiments of the present invention, even if the input force is zero. Such a self-locking brake can be set in motion by a force at the input, and when the input force is removed may remain motionless, “locked” by friction at whatever position they were left.

As used herein, a person skilled in the relevant art may generally understand the term “Geneva mechanism”, “Geneva drive”, or “Maltese Cross” as used herein to refer to the well-known gear mechanism that translates a continuous or uniform rotation into an intermittent or incremental rotary motion. It may be understood that such intermittent rotary motion may be referred to as “indexed” motion or that the follower wheel is indexed. Such a configuration generally provides a rotating drive wheel having a drive pin that reaches into or engages with a slot of a driven or follower wheel advancing the driven or follower wheel by one step. Such a mechanism may further comprise the follower wheel having a plurality of radially extending generally linearly straight slots spaced equally around the periphery of the follower wheel. Interposed between these slots may be a plurality of guide surfaces, which, like the slots, are uniformly dimensioned and arranged. These guide surfaces can be shaped to interact with the blocking disc or restraining cam of the drive wheel. The drive wheel may also have a raised circular blocking disc or restraining cam that assists in locking the driven wheel in position between steps. The restraining cam can be configured to interact with the cam guide surfaces of the follower wheel (e.g. convex). The interaction of the restraining cam with the cam guide restrain the follower wheel from experiencing rotary motion except during the periods in which the follower wheel is driven by the drive pin. The follower wheel is thus restrained intermittently, and in a manner such that the straight slots sequentially receive the drive pin. It may be understood that any device or configuration of devices which translate continuous rotational motion into intermittent rotation motion would be considered a Geneva mechanism in accordance with the present invention.

In the description and drawings herein, and unless noted otherwise, the terms “vertical”, “lateral” and “horizontal”, are generally references to a Cartesian co-ordinate system in which the vertical direction generally extends in an “up and down” orientation from bottom to top (y-axis) while the lateral direction generally extends in a “left to right” or “side to side” orientation (x-axis). In addition, the horizontal direction may extend in a “front to back” orientation and can extend in an orientation that may extend out from or into the page (z-axis). Unless indicated otherwise, the force or vector of gravity acts parallel to the y-axis (e.g., the vertical direction) in a general downward manner.

As used herein, the term “cantilever” or “cantilevered” refers to apparatus or systems in which there generally is a projecting structure, such as an arm or beam, that may be supported or fixed at one end and carries a load at the other end or along its length. It will be apparent from the description herein that some embodiments are illustrated using a cantilever design, while other alternatives may use a supported beam design. It is to be understood for example, that a design with a single beam that is supported by a support near the mid-point of its length, may be thought of as similar to two separate cantilevers that are affixed to the support at one end and that engage brake drums at their other end.

As used herein, a person skilled in the relevant art would understand a “cam” to refer to component that rotates or reciprocates (e.g. slides back and forth) to provide a prescribed or variable motion in an interacting element, which is generally referred to as a cam follower or follower. More specifically, a cam is a rotating or sliding piece in a mechanical linkage that may be used in transforming rotary motion into linear motion or vice-versa. It may be further understood that it may comprise a rotating wheel (e.g. an eccentric wheel) or shaft (e.g. a cylinder with an irregular shape) in which the follower can travel along a regular (e.g. circular) or irregular (e.g. elliptical) path. In the preferred embodiment of the present invention, a cam may be understood to comprise an eccentric disc or other shape that produces a smooth reciprocating motion in the cam follower, which is a lever making contact with the cam. A cam follower, also known as a track follower, may comprise a roller designed to follow the cam profile. A person skilled in the relevant art would understand that a cam follower or follower may come in an array of different configurations. In the context of the present invention as described herein, a cam may be any structure or device that is set relative to a pivot of a joint, to exert a prescribed or variable motion on an interacting element (e.g. cam follower) wherein the interacting element or follower then transfers the reciprocating motion on to another element (e.g. a beam carriage). Cams can be varied shape so as impart a desired linear deflection of the force generating device. A cam may be set eccentrically (e.g. not placed centrally or not having its axis or other part placed centrally) relative to a central axis of a pivot of a joint. A cam may be mounted within the circumference of a joint. Alternatively, a cam need not be mounted entirely within the circumference of a joint, and may readily be set outside the circumference of a joint where full rotation is unnecessary or where physical collision or interference of mechanical components is not a concern, for example as may be the case for large industrial robotic arms. One example of a cam is an eccentric bearing. Another example of a cam is a lever extending from the joint that can interact with a force generating device.

A preferred embodiment of the present invention may be useful for applications requiring self-locking or braking in one or more degrees of freedom. A more preferred embodiment of the present invention allows multiple brakes to be engaged and disengaged from a single point of adjustment. By turning a single knob, a user may be able to engage and disengage varying combination of brakes until a desired braking configuration is reached. The invention avoids forcing the user to interact with an individual actuator for each brake. The user can also quickly identify which brakes are currently engaged and disengaged by referring to the orientation of the single knob. The brake design can be manufactured out of non-magnetic materials allowing it to be used in magnetically sensitive environments. The invention is purely mechanical and does not require the use of additional pneumatics, hydraulics, or electronics which may be required for other conventional braking methods.

Furthermore, the invention does not require that all brakes be simultaneously engaged or disengaged from this single adjustment point. The Geneva mechanism provides a method for indexing the engagement of the brakes. Indexing allows the brakes to be engaged on and off in various combinations that are desirable for a particular application.

The invention was initially developed for a device (i.e. a robotic arm) used in magnetic resonance (MR) image-guided focal therapy of the prostate. The device consists of two parallel arms each containing two degrees of freedom. The end user of the device requires the ability to lock these arms during the focal therapy procedure. The simplest approach for this requirement would be to brake each of the four degrees of freedom independently using four separate handles. However, tightening and loosening four different handles was deemed to be cumbersome. Furthermore, this braking scheme would not provide a clear visual indication of which brakes were engaged of disengaged. As an alternative, the invention outlined in this disclosure was developed. The user engages the brake system (which can incorporate an indexing mechanism to selectively control the separate brakes, as described later) by turning a single knob with four different positions, where each position may correspond to: (1) both arms unlocked simultaneously; (2) arm 1 fully (i.e. in both clockwise and anticlockwise directions) locked, and arm 2 unlocked; (3) arm 1 unlocked, and arm 2 fully locked; and (4) both arms fully locked simultaneously. In this case, the single knob is much easier and faster for the user to engage than multiple knobs. The user can also quickly visually refer to the knob to identify the current braking configuration of the system.

In order that the invention may be more fully understood, it will now be described, by way of example, with reference to the accompanying drawings in which FIG. 1 through FIG. 7 illustrate embodiments of the present invention.

An embodiment of the present invention provides for unidirectional or bidirectional self-locking or braking mechanisms which employ a cantilever-based braking system. Another embodiment of the present invention provides for indexed braking or locking mechanisms. As shown in FIG. 1, there is provided a schematic illustration of the cantilevered braking or self-locking system 5 in accordance with the embodiments of the present invention. Mathematically, the invention can be described using beam theory exemplified by a cantilevered beam or arm with a single point load at P. A projecting structure, such as a beam 10, is fixed or supported at one end to a fixed support 20 and carries a load at the other end or along its length. A schematic of this beam bending type is shown in FIG. 1. In a preferred embodiment, such as shown in FIG. 1, there is provided an arm or beam 10, which in a preferred embodiment may be flexible (e.g. capable of flexing, deflexing or bending without breaking upon the application of a force), attached to a fixed surface 20, thereby forming a cantilever. For a cantilevered beam having a single point load, the force (P) required to deflect the beam by application of such load force can be represented in relation to a number of parameters. The force P is applied at a point a distance (a) along the beam of total length L. Using beam theory, this relationship can be expressed mathematically, with reference to FIG. 1, as provided below:

$$\begin{matrix}P = \frac{3 {δ}_{load} EI}{{a}^{3}} & ( 1 ) \\ {δ}_{max} = \frac{P {a}^{2}}{6 EI} ( 3 L - a ) & ( 2 )\end{matrix}$$

where E is the modulus of elasticity of the beam material and I is the area moment of inertia of the beam cross section. Equation 1 describes the force, P, that is required to deflect the cantilevered beam a given distance at a point along its length. Equation 2 describes the deflection of the cantilevered beam at its tip given a force at a particular point along its length.

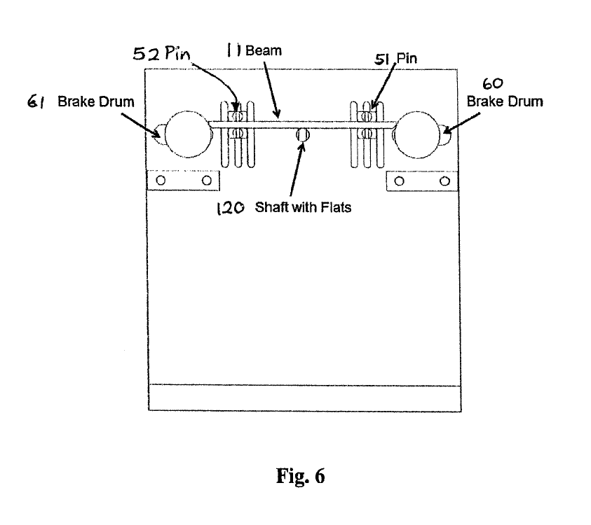

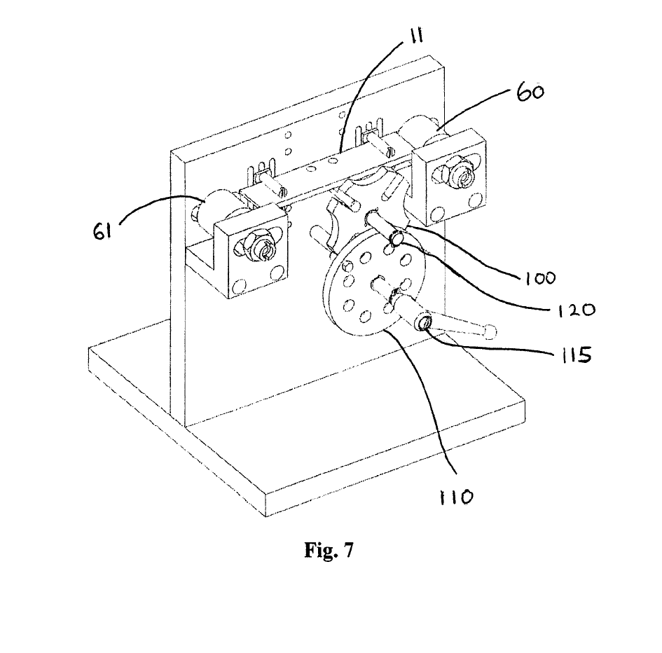

The bending behavior described by these equations can be used to design a braking mechanism in such a manner that the beam 10 can be deflected so as to engage a brake drum resulting in a braking behavior. It may be understood later in the specification that this can be used to aid in releasing the brake as illustrated in FIGS. 6 and 7.

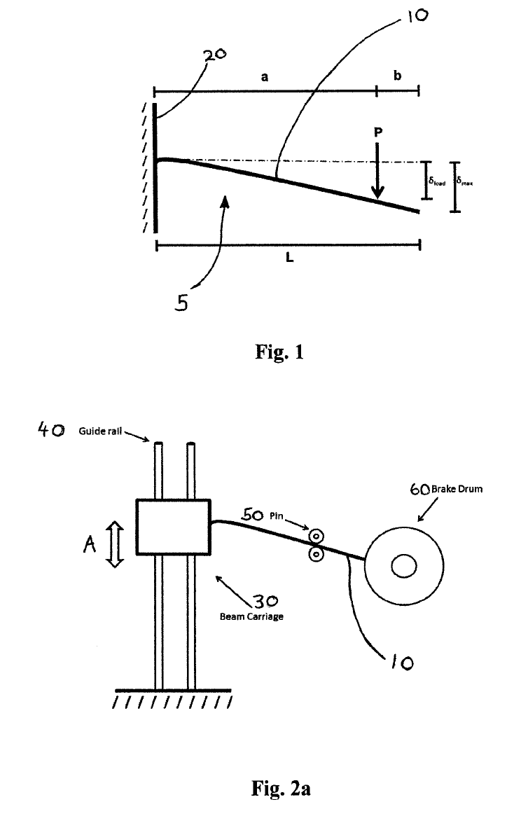

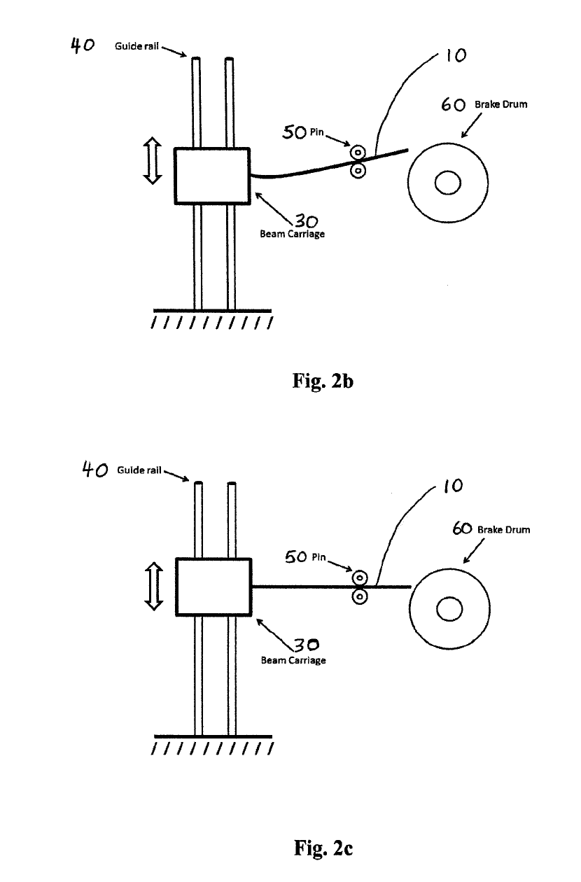

Referring to FIG. 2a, there is provided an embodiment of the present invention illustrating a braking mechanism in accordance with a preferred embodiment (sometimes referred to herein as a “one-way” or unidirectional brake) that utilizes a cantilevered system as noted above. As shown in FIG. 2a, arm or beam 10 is attached to beam carriage 30 at a first end. Along the horizontal axis of beam 10 are disposed guide pins 50. It may be understood that any configuration of guide pins at any specific location along the length of beam 10 could be provided in accordance with the invention. Carriage 30 may be movably positioned along one or more guide rails 40 through a generally vertical axis represented by arrow A; in other words, carriage 30 can be understood to generally move up and down along the length of the guide rails along the vertical axis represented by arrow A. The free end (the end distal to carriage 30) of the beam 10 is positioned proximal to a rotatable brake drum 60 such that deflection of beam 10 can result in the beam 10 frictionally engaging and disengaging drum 60. It may be understood that as carriage 30 moves vertically along guide rails 40, the guide pins 50 exert a force on the beam 10, causing the beam 10 to deflect in varying degrees so that the distal end of beam 10 may frictionally engage or disengage drum 60 in such a manner as would be understood to result in the self-locking or braking activity of an aspect of the present invention. (It should be understood that alternative configurations are possible besides the carriage and guide pin arrangement show in this particular embodiment. Any method capable of exerting a force along the length of the beam could potentially be used, including methods such as mechanical linkages, pneumatics, hydraulics, eccentric cams or lead screws). For example, as shown in FIG. 2c, beam 10 is shown in a position where beam 10 is not deflected and the distal end does not engage drum 60. If the beam carriage 30 is moved upwards along the vertical axis (see FIG. 2a), beam 10 is deflected downwards such that the free end of the beam deflects and engages brake drum 60. Depending on the degree of deflection and the angle at which the free end of beam 10 contacts or frictionally engages the surface of drum 60, the brake may be activated. With the braking action engaged, the brake drum 60 is unable to rotate in one direction (e.g. clockwise as provided in FIG. 2a) but may be able to move in the opposite direction (e.g. counterclockwise in FIG. 2a). The force that the guide pin(s) exert on the beam is dictated by equation 1, where δ_{load} is the distance traveled by the beam carriage from its position with no beam deflection. Equation 2 dictates the distance the end of the beam may travel, i.e. δₘₐₓ. The distance δₘₐₓ must be sufficient to drive the end of the beam 10 into the surface of the brake drum 60 and frictionally engage therewith.

As shown in FIG. 2a, it can be seen that beam 10 deflects and engages brake drum 60 at an angle relative to a horizontal axis of brake drum 60. The angle formed between a horizontal line from axis of the brake drum 60 and the line from the axis of the brake drum to the point at which the beam engages the surface of the brake drum 60 is referred to as the engagement angle. The critical angle is a fixed constant value that defines the maximum engagement angle for the brake to achieve self-locking. When beam 10 deflects and frictionally engages the surface of drum 60 such that the engagement angle is at or below the critical angle, then there may be self-locking in one direction. If the engagement angle is above the critical angle, then self-locking will not occur. As shown in FIG. 2a, the direction in which the brake drum 60 is locked is clockwise. In the opposite direction of rotation, drum 60 may still be able to rotate. In other words, drum 60 is self-locked in a first direction (e.g. clockwise) and rotatable in a second direction (e.g. counterclockwise). In the first direction, the rotation of drum 60 may never be able to overcome the frictional forces; in the second direction, the rotation of drum 60 could, with sufficient force, overcome the frictional forces.

It may be understood that the critical angle of the present invention is dependent on the coefficient of friction between the end of the beam 10 and the brake drum 60; this means that the critical angle may depend on a number of factors such as the material of the beam 10 and the drum where they engage each other. The engagement angle on the other hand is dependent on the geometry of the brake, including factors such as the location of the guide pins and the brake drum, as well as the length of the beam and the diameter of the brake drum, etc. A person skilled in the relevant art would be able to calculate, based on known methods, the critical angle required for each particular set up of the present invention.

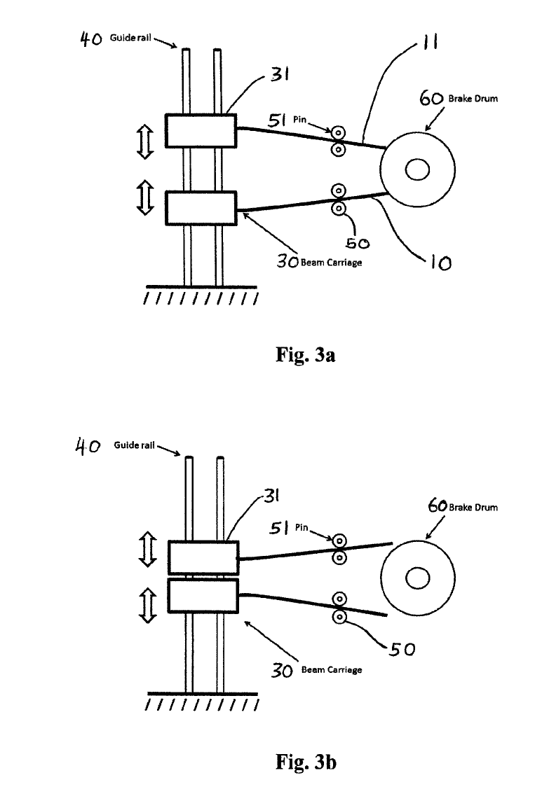

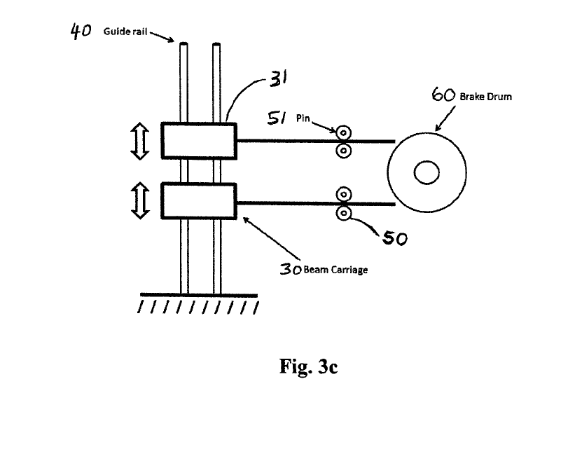

The brake drum 60 generally represents herein any rotatable element or part that requires braking, locking, or, preferably, self-locking. Although not shown in FIGS. 2a to 3c, brake drum 60 may in turn be engaged with other moving parts, rotatable or otherwise, which the brake drum operates to brake or lock. For example, the brake drum may be engaged with a rotatable shaft, in which case the braking mechanism has particular application for the braking of rotatable shafts.

As shown in FIG. 2b, moving the beam carriage 30 downwards along the vertical axis, may result in the deflection of the beam 10 upwards such that the free or distal end of the beam disengages the brake drum 60, thereby disengaging the braking or self-locking action. If the angle at which the beam 10 frictionally engages the surface of drum 60 is equal to or less than the critical angle, the braking action of the beam behaves as a self-locking mechanism. Self-locking behavior results in the beam exerting a high braking force on the brake drum 60, while requiring relatively minimal force by the user to engage the brake. Thus the disclosed invention provides for a self-locking braking mechanism which can be readily engaged and disengaged with little or no force by the user.

In accordance with another aspect of the invention, FIGS. 3a, 3b and 3c illustrate a variation (sometimes referred to herein as a “two-way” or bidirectional brake”) of a preferred embodiment of the present invention. Referring to FIG. 3a, a first or upper beam carriage 31, a first or upper set of guide pins 51 and a first or upper beam 11 are provided. This is equivalent to the system shown in FIG. 2a. There is also provided in FIG. 3a a second or lower cantilevered system that is the mirror image of the apparatus shown in FIG. 2a. The upper (first) and lower (second) beam carriages 30, 31, both mounted onto the guide rail 40, can be synchronized or “synced” such that they each move the same distance towards or away from each other (e.g. together or apart), as described in more detail herein. As the two beam carriages move, their corresponding beams 10, 11 may either simultaneously be deflected in a similar mirror opposite manner, such that the beams either engage the brake (as shown in FIG. 3a) or simultaneously be less deflected in a similar mirror opposite manner so as to disengage the self-locking mechanism (as shown in FIG. 3b). FIG. 3c illustrates the configuration where the beams 10 and 11 are not deflected and do not engage drum 60. By being configured in this manner it may be understood that the upper braking apparatus functions in the manner as described in FIG. 2a, while the lower braking apparatus, as a mirror image of the upper apparatus, may function in the mirror opposite function. As beam carriage 31 moves upwards along the vertical axis, carriage 30 would move downwards along the vertical axis in a mirror opposite manner to that of carriage 31. In other words, the upper braking apparatus as shown in FIG. 3a, has drum 60 self-locked in a first direction (e.g. clockwise) and rotatable in a second direction (e.g. counterclockwise). The lower braking apparatus as shown in FIG. 3a, has drum 60 self-locked in the second direction (e.g. counterclockwise) and rotatable in the first direction (e.g. clockwise). As a result, when the braking system shown in FIG. 3a is engaged, the rotation of drum 60 may never be able to overcome the frictional forces in either direction.

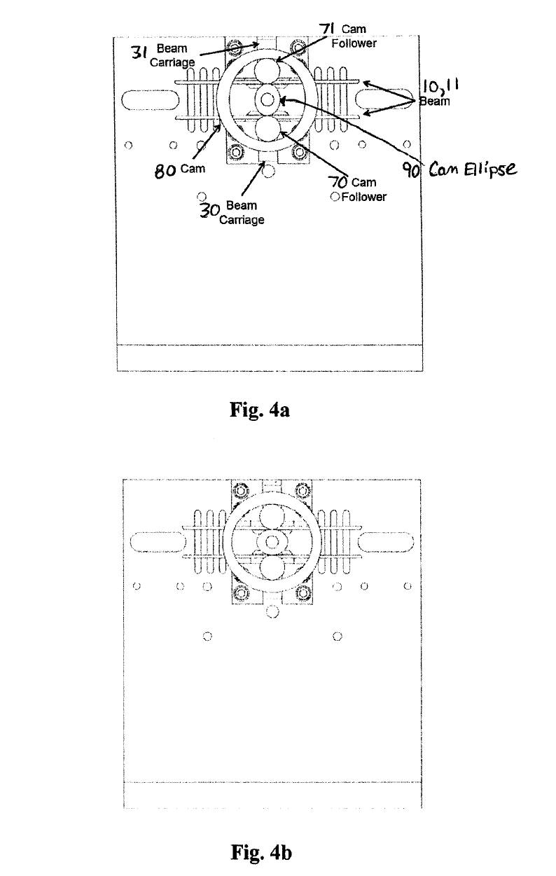

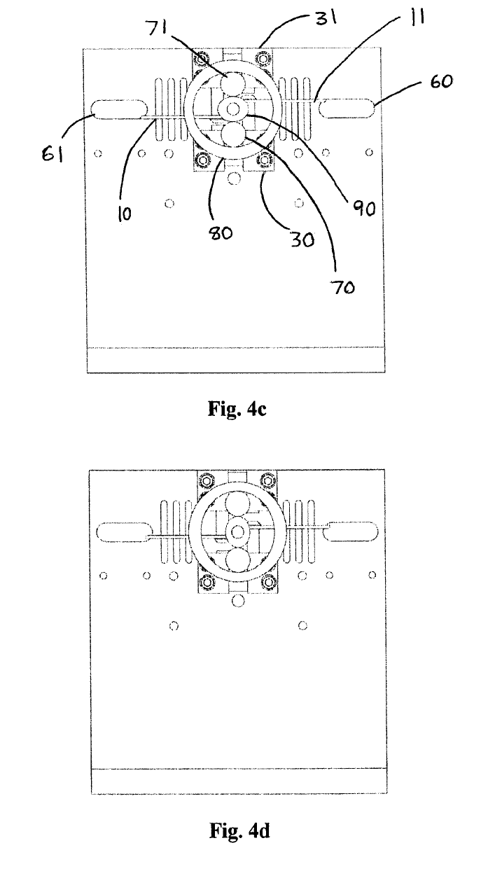

FIGS. 4a and 4b illustrate a preferred embodiment for synchronizing the beam carriages to arrive at the bidirectional self-locking mechanism. FIGS. 4a and 4b provide a cross-sectional view of the mechanism, where the section is cut midway through cam 80. Attached to each beam carriage 30, 31 is a cam follower 70, 71 respectively. The cam follower sits within a generally elliptical track defined by the cam 80 and cam ellipse 90. The cam 80 and cam ellipse 90 are integrated together (although in FIGS. 4a and 4b, they appear as separate parts because of the sectional view). As the cam 80 rotates, the cam followers may follow the cam track causing the beam carriages 30, 31 to move either away from each other (“outwards”), thereby engaging the brake, or towards each other (“inwards”), thereby disengaging the brake. The cam followers (70 and 71) are in geared or constrained engagement with the cam 80 and with the cam ellipse 90. (For simplicity of illustration, the one or more corresponding brake drums, which would be positioned close to the free (or distal) ends of each beam, on one or both sides, have not been shown; in FIGS. 4a and 4b, the guide pins, as well as the actual deflection of the beams, are also not shown). The brake may be fully frictionally engaged when the cam followers (70 and 71) are at the major diameter of the cam ellipse 90 (FIG. 4a) and fully disengaged when the cam followers are at the minor diameter of the cam ellipse 90 (FIG. 4b). The user can engage and disengage the brake by rotating a handle (not shown) attached to the cam 80. It is understood that this cam and cam follower mechanism can also be used for a one-way brake with a single beam carriage.

FIGS. 4c and 4d provide a cross sectional view of a variation of the self-locking brake configuration shown in FIGS. 4a and 4b, where the section is cut midway through cam 80.

In this case, an upper beam 10 is fixedly connected to a lower beam carriage 30, and a lower beam 11 is fixedly connected to an upper beam carriage 31. Referring to FIG. 4c, in this configuration, the brake can be configured such that when the cam followers (70 and 71) are at the minor diameter of the cam ellipse 90, the beam carriages (31 and 30) are pushed relatively further apart, causing the brake drums 60 and 61 to be engaged and braked. Referring to FIG. 4d, when the cam followers are at the major diameter of the cam ellipse 90, the beam carriages (31 and 30) are pushed closer together, causing the brake to disengage from brake drums 60 and 61.

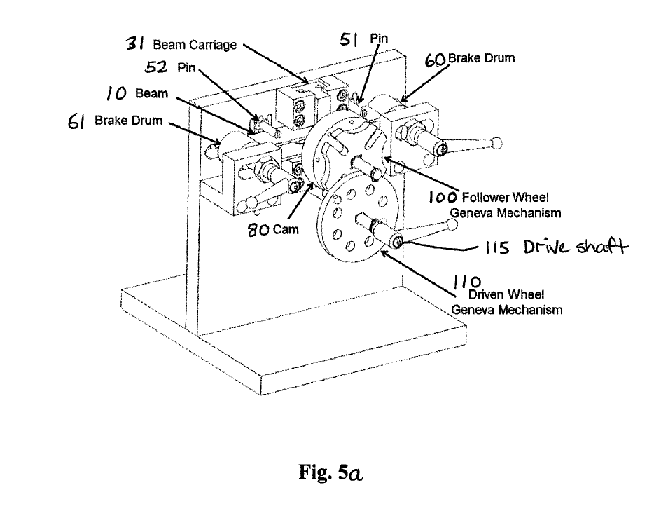

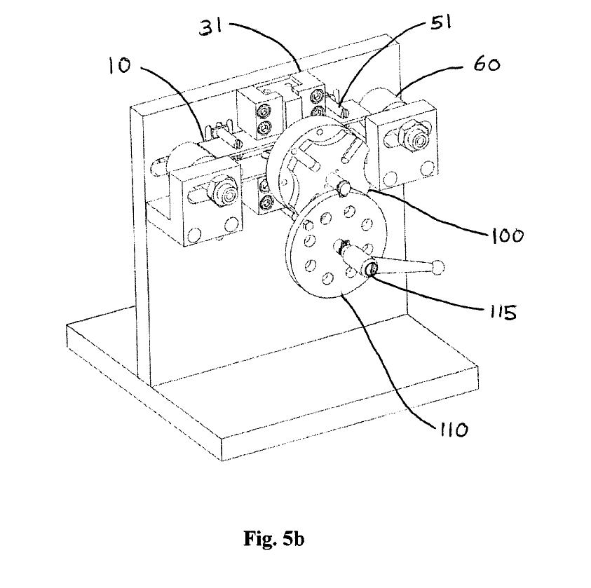

The rotation of the brake cam described in FIGS. 4a and 4b can be indexed through the use of a conventional or well-known Geneva mechanism (see FIG. 5). A Geneva mechanism converts continuous rotary motion into intermittent rotary motion. For every 360° rotation of a drive shaft, a Geneva mechanism can be used to step a follower shaft through a desired number of steps of a fixed angle. The Geneva mechanism follower can in turn be used to drive the rotation of the brake cam. By way of example, if the Geneva mechanism step size is 90°, each step may alternate the position of the cam followers (70 and 71) between the major and minor diameters of the cam ellipse 90. Alternating the cam followers between the major and minor diameters of the cam ellipse may result in alternating between the self-locking brake or locking function being engaged and disengaged. If the Geneva mechanism steps n number of times per full rotation of the drive shaft, the user must rotate the drive shaft 360/n degrees to engage or disengage the brakes. In accordance with an aspect of the invention, an indexed braking system can be configured, for example, using a plurality of the brake and Geneva mechanism shown in FIG. 5, where each Geneva mechanism is engaged with a common drive shaft. Geneva mechanisms of varying n number of steps can be driven by the common drive shaft and used to drive the cams of a plurality of brakes. The varying Geneva mechanisms may result in the brakes engaging and disengaging at different rates. As the user rotates the drive shaft, different combinations of brakes may be engaged and disengaged. The user can use the drive shaft as a single point of adjustment to achieve a desired combination of braking. The user can also visually refer to the orientation of the drive shaft (or of a knob/handle engaged with the drive shaft) to quickly determine the braking configuration of the system. Table 1 below provides an example of how such a setup might operate.

TABLE 1

| | Brake 1 | Brake 2 |
|---|---|---|
| | (Geneva | (Geneva |
| Drive Shaft | Mechanism | Mechanism |
| Angle | n = 2) | n = 4) |
| 0° | Disengaged | Disengaged |
| 90° | Disengaged | Engaged |
| 180° | Engaged | Disengaged |
| 270° | Engaged | Engaged |
| 360° | Disengaged | Disengaged |

For the purposes of illustration, in the example contemplated in Table 1, one Geneva mechanism having n=2 would operate on one brake drum (Brake 1); another Geneva mechanism having n=4 would operate on a second brake drum (Brake 2). Thus, the orientation of the driven wheel (or the angle of the drive shaft) would affect different configurations of braking for Brake 1 and Brake 2 (and or any rotatable shafts engaged with the respective brake drums). It may be understood that the embodiments of the present invention would not be restricted to the examples provided herein but that any desired configurations could be achieved.

FIG. 5a shows an embodiment of the present invention wherein the bidirectional self-locking mechanism of FIGS. 4a and 4b is provided with the addition of a Geneva mechanism to index the braking action. As shown in FIG. 5a, there is provided the two-way self-locking or braking mechanism, which can operate to lock the shafts of two brake drums (60 and 61). In this particular configuration, the brake drums (60 and 61) are both engaged or disengaged at the same time. The driven wheel 110 of the Geneva mechanism is rigidly attached to a drive shaft 115 with a handle (a knob may also be used in place of the handle). The follower wheel 100 of the Geneva mechanism is rigidly attached to the brake cam 80. The user turns the handle of the Geneva mechanism driven wheel 110, which in turn indexes the follower wheel 100 and brake cam 80. As the brake cam 80 indexes with each step, the brake drums (60 and 61) are correspondingly engaged and disengaged. Furthermore, a user can readily ascertain at a glance whether the braking configuration of the brakes is as desired, by reference to the position/orientation of the Geneva driven wheel 110. It is understood that this indexed braking mechanism may be adapted to provide for indexed braking for a plurality of brakes (i.e. brake drums). Through the appropriate selection of Geneva mechanisms, various positions of the drive shaft can correspond to various configurations of engagement or disengagement of each of the respective brakes. If each of the brake drums is engaged to a rotatable brake shaft, the braking mechanism can thus be used to provide for the indexed braking of multiple shafts. Such a system for indexed braking may be configured by providing a common drive draft, and a plurality of Geneva mechanisms, each Geneva mechanism being engaged with and driven by the common drive shaft, and where each Geneva mechanism is engaged with a corresponding one-way brake or two-way brake, thus providing for index braking of such brakes. Optionally, one or more of the Geneva mechanisms may be configured to engage with more than one one-way brake or two-way brakes, where it is desired that specific brakes be engaged or disengaged in a synchronized fashion.

FIG. 5b is identical to FIG. 5a, except that the handles on the brake shafts have been removed for easier reference.

FIG. 6 shows a cross-sectional view of an alternative brake mechanism in accordance with the present invention. The embodiment provided in FIGS. 6 and 7 are contrasted to the embodiments shown in FIGS. 4 and 5. The embodiments of the present invention shown in FIGS. 4 and 5 provided two beams while the embodiments shown in FIGS. 6 and 7 comprise only one beam. It may be understood by a person skilled in the relevant art that embodiments shown in FIGS. 4 and 5 could just as easily use a single beam and the embodiments in FIGS. 6 and 7 could use two beams. It is very simple to switch between using one beam or two. The difference between using one or two beams is that, in the former, the brake drums are locked in one direction, but in the latter, they are locked in both directions. The brake consists of a single beam 11 trapped between two sets of pins (51 and 52). The beam 11 can be configured so that it is preloaded, such that in its resting state it is deflected/bent and engaging the brake drums (60 and 61). (The actual beam deflection is not shown in FIG. 6). At its center, the beam is supported by a shaft 120 with two flats machined onto opposite sides. The shaft 120 can freely rotate. As the shaft 120 rotates, the beam 11 may rest against either the round or flat portion of the shaft. When the beam 11 is resting on the round portion of the shaft, the round portion of the shaft pushes the beam 11 upwards, pulling the free ends of the beam away from the brake drums (60 and 61) and releasing both brakes. When the beam is resting on the flat portion of the shaft 120, this may allow the preloaded beam to contact the brake drums (60 and 61) and engage both brakes. Shaft 120 serves the same function as the cam in the previously described example (FIG. 4a). By rotating the shaft 120, the user can engage and disengage the brake as required. Although in this particular embodiment, the brake mechanism is shown with a single beam, it is understood that two beams positioned above and below the shaft may also be used. Further, shaft 120 may also be used as a syncing mechanism for the two-way brake in FIG. 3a, wherein the shaft can directly actuate the upper and lower beam carriages rather than the beam. One of the advantages of using this system wherein the beam is preloaded against the shaft is that beam carriages and guide rails are no longer required.

FIG. 7 shows a brake with the embodiments described in association with FIG. 6, but fitted with a Geneva mechanism. The Geneva mechanism, comprising a driven wheel 110 and a follower wheel 100, is used to rotate the shaft 120. Each step of the Geneva mechanism alternates between the round portion and the flat portion of the shaft 120 contacting beam 11. Each step of the Geneva mechanism may result in the brakes (60 and 61) engaging or disengaging as the shaft of the driven wheel 110 is rotated. If a braking system is configured with a plurality of the “beam and shaft brakes with Geneva mechanisms” of FIG. 7, where each respective Geneva mechanism or drive wheel engages a common drive shaft, may be coordinated to achieve varying combinations of brake engagement/disengagement from a single point of adjustment, in similar fashion as for the double beam and cam design shown in FIG. 5.

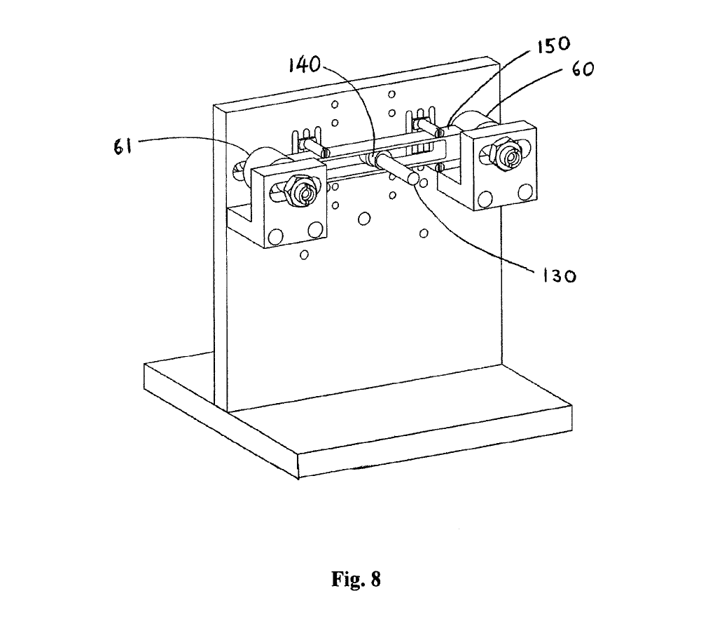

FIG. 8 illustrates a further alternative design of the brake, which utilises a box frame and cam. In this embodiment, there is a rotatable shaft 130, which can freely rotate about its central axis. A cam 140 is disposed around the shaft 130 and affixed thereto. The cam 140 uses two eccentric cams spaced 180° apart. The cam 140 as shown has two eccentric radii, such that the dimension of the cam in a first direction is greater than its dimension in a second direction (as shown the first direction and second direction are 90° to each other). The direction of the first cam's maximum radius is offset from the direction of the second cam's maximum by 180°. In this embodiment, the two beams have been integrated into a box frame 150. The cam 140 is biased against both the upper frame (beam) and lower frame (beam) of the box frame 150. The brake can be configured such that when the cam 140 is positioned with its minimum dimension aligned with the points where the cam engages the upper and lower frames of the box frame 150 (i.e. in the vertical direction), the brake is preloaded so that the brake drums (60 and 61) are engaged. When the shaft 130 and cam 140 are rotated (in this case, by 90°) such that the cam's maximum dimension is aligned with the points where the cam engages the upper and lower frames of the box frame 150 (i.e. in the vertical direction), this causes the cam to push the upper and lower frames of the box frame 150 further apart and at the same time causes the ends of the box frame which engage with the brake drums (60 and 61) to pull away from the brake drums, thereby disengaging the brake.

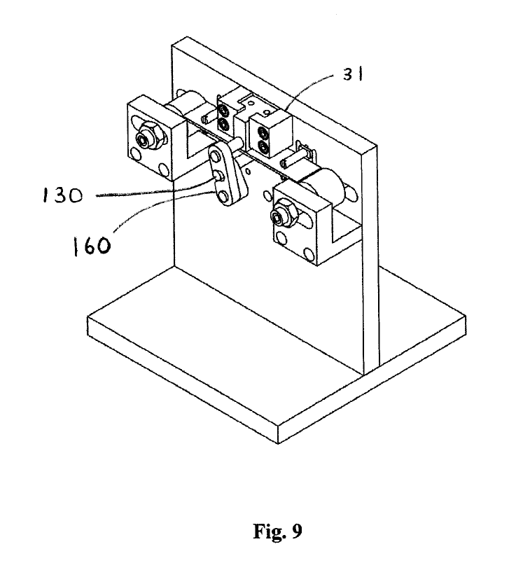

FIG. 9 illustrates a further alternative design of the brake, which utilises an alternative beam and toggle configuration. As the rotatable shaft 130 is rotated, the mechanical linkages 160 operate to exert a force on the beam carriage 31, which in turn deflects the beam and causes its distal ends to engage the brake drums. When the rotatable shaft 130 is rotated further, the mechanical linkages 160 operate to release the force exerted on the beam carriage 31, allowing the beam to straighten out and disengage the brake drums.

It is contemplated that the disclosed inventions, being generally of relatively simple construction, could be manufactured from non-magnetic materials. This makes the present invention particularly suited to application in magnetically sensitive environments, such as for example in the bore of a magnetic resonance scanner.

Further, the present invention can be a purely mechanical device, which, as such, does not require the use of additional pneumatics, hydraulics or electronics, which may be required for conventional braking methods. This aspect makes the invention relatively durable, potentially less prone to breakdown or damage, and potentially easier to manufacture/repair.

The embodiments described herein are not, and are not intended to be, limiting in any sense. One of ordinary skill in the art may recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

1. A self-locking braking system comprising:
a resilient support;
a cantilever having a first end and a second end, the first end fixedly connected to the resilient support and a second end proximal to a rotatable drum rotatable in a first and second rotation direction; and
a deflecting means;
wherein the resilient support and the deflecting means are configured to interact with each other to cause the cantilever to deflect and the second end of the cantilever to frictionally engage the rotatable drum at a point of engagement, where the torque generated by rotation of the drum in the first rotation direction is less than or equal to the force of friction at the point of engagement.

2. The self-locking braking system of claim 1, wherein the resilient support is a carriage movable along a first axis in a first and second direction, wherein the movement of the carriage in the first direction causes the cantilever to interact with the deflecting means such that the cantilever deflects and the second end of the cantilever frictionally engages the rotatable drum at a point of engagement.

3. The self-locking braking system of claim 1, wherein the deflecting means is a guide pin disposed proximate to a point along the cantilever.

4. The self-locking braking system of claim 1, wherein, the torque generated from rotation of the drum in the second rotation direction is greater than the force of friction at the point of engagement.

5. The self-locking braking system of claim 2, wherein the movement of the carriage in the second direction causes the cantilever to disengage the rotatable drum.

6. A self-locking braking system comprising:
a first and second resilient support;
a first cantilever having a first end and a second end, the first end fixedly connected to the first resilient support and a second end proximal to a rotatable drum rotatable in a first and second rotation direction;
a second cantilever having a first end and a second end, the first end fixedly connected to the second resilient support and a second end proximal to the rotatable drum; and
a first deflecting means and a second deflecting means;
wherein the first resilient support and the first deflecting means are configured to interact with each other to cause the first cantilever to deflect and the second end of the first cantilever to frictionally engage the rotatable drum at a first point of engagement, where the torque generated by rotation of the drum in the first rotation direction is less than or equal to the force of friction at the first point of engagement, and wherein the second resilient support and the second deflecting means are configured to interact with each other to cause the second cantilever to deflect and the second end of the second cantilever to frictionally engage the rotatable drum at a second point of engagement, where the torque generated by rotation of the drum in the second rotation direction is less than or equal to the force of friction at the second point of engagement.

7. The self-locking braking system of claim 6, wherein the first and second resilient support, the first and second cantilever, and the first and second deflecting means, are configured such that a deflection of the first cantilever in a second direction causes a corresponding deflection of the second cantilever in a first direction, and a deflection of the first cantilever in a first direction causes and a corresponding deflection of the second cantilever in a second direction.

8. The self-locking braking system of claim 6, wherein the first resilient support is a first carriage movable along a first axis in a first and second direction, and the second resilient support is a second carriage movable along the first axis in the first and second direction,
wherein the movement of the first carriage in the first direction causes the first cantilever to interact with the first deflecting means such that the first cantilever deflects and the second end of the first cantilever frictionally engages the rotatable drum at the first point of engagement, where the torque generated by rotation of the rotatable drum in the first rotation direction is less than or equal to the force of friction at the first point of engagement and the movement of the second carriage in the second direction causes the second cantilever to interact with the second deflecting means such that the second cantilever deflects and the second end of the second cantilever frictionally engages the rotatable drum at a second point of engagement, where the torque generated by rotation of the rotatable drum in the second rotation direction is less than or equal to the force of friction at the second point of engagement.

9. The self-locking braking system of claim 8, wherein the first carriage and the second carriage are synchronized such that a movement of the first carriage in the first direction causes a corresponding movement of the second carriage in the second direction, and a movement of the first carriage in the second direction causes a corresponding movement of the second carriage in the first direction.

10. The self-locking braking system of claim 9, further comprising a cam rotatable in a first or second rotation direction, the cam engaging the first and second carriages,
wherein rotating the cam about the first direction moves the first carriage along the first axis in the first direction and the second carriage along the first axis in the second direction; and
wherein rotating the cam about the second direction moves the first carriage along the first axis in the second direction and the second carriage along the first axis in the first direction.

11. The self-locking braking system of claim 8, wherein the movement of the first carriage in the first direction and the movement of the second carriage in the second direction, cause the first and second cantilevers to lock the drum from rotating in both a first and second rotation direction.

12. The self-locking braking system of claim 8 wherein the first and second deflecting means are a guide pin disposed proximate to a point along the first cantilever and a guide pin disposed proximate to a point along the second cantilever, respectively.

13. A system for indexed braking of a plurality of rotatable brake shafts, comprising:
a plurality of self-locking braking systems of claim 1, wherein a rotatable drum of each said plurality of self-locking braking systems is engaged with one of the plurality of rotatable brake shafts;
a plurality of Geneva mechanisms, wherein each Geneva mechanism is engaged with at least one of the plurality of self-locking braking systems; and
a rotatable drive shaft, engaged with each one of the plurality of Geneva mechanisms;
wherein the rotation of the drive shaft through different positions provides for the selective engagement and disengagement of each of the plurality of rotatable drums and each corresponding rotatable brake shaft.

14. The system for indexed braking of a plurality of rotatable shafts of claim 13, wherein each Geneva mechanism comprises:
a driven wheel, affixed to the rotatable drive shaft; and
a follower wheel, each follower wheel in engagement with a beam carriage of a self-locking braking system and in constrained engagement with the driven wheel, wherein the driven wheel and follower wheel are configured to convert rotary motion of the driven wheel into intermittent rotary motion of the follower wheel.

15. (canceled)

16. (canceled)

17. (canceled)

18. (canceled)

19. The self-locking braking system of claim 1, wherein substantially all the components thereof are made from non-magnetic materials.

20. The system of claim 13, wherein substantially all the components thereof are made from non-magnetic materials.
